(19) United States
(12) Patent Application Publication
(10) Pub. No.: US 2025/0150560 A1
(43) Pub. Date: May 8, 2025

(54) SYSTEM FOR AUTOMATICALLY CAPTURING, STORING, AND DISPLAYING PHOTOGRAPHS

(71) Applicant: TwinMotion, LLC, McAlester, OK (US)

(72) Inventors: Jodie Green, McAlester, OK (US); Jamie Tarron, McAlester, OK (US)

(73) Assignee: TwinMotion, LLC, McAlester, OK (US)

(21) Appl. No.: 18/904,147

(22) Filed: Oct. 2, 2024

Related U.S. Application Data
(60) Provisional application No. 63/547,558, filed on Nov. 7, 2023.

(51) Int. Cl. H04N 7/18; H04N 23/51

(52) U.S. Cl. CPC H04N 7/188; H04N 23/51

(57) ABSTRACT

Described herein is a camera system for automatically taking, storing, and displaying photographs of customers to customers and method for using. The camera system comprises a camera, tracking system, control system, and display device. The method of using the system comprises taking a photograph, identifying the subject of the photograph with the tracking system, storing the photograph, and displaying the photograph to the appropriate customer.

### BACKGROUND OF THE INVENTION

### Cross Reference

This application is based on and claims priority to U.S. Provisional Application No. 63/547,558 filed Nov. 7, 2023.

### FIELD OF THE INVENTION

This invention relates generally to a photo capture and display system, and more particularly, but not by way of limitation, to a system for automatically capturing photographs of activity participants by various means and providing access to participants of the photographs taken of them.

### DESCRIPTION OF THE RELATED ART

Thousands of families every year flock to various ski resorts, theme parks, conventions, and other vacation spots to make lifetime memories together. Typically, individuals choose to preserve those memories by way of photography. While posing for photographs is typical, it can be difficult to capture candid moments of families and individuals participating in vacation activities.

More particularly, families and individuals on ski trips often desire to have photographs of themselves or their loved ones “in action,” and attempts to do so often result in blurry photographs, far away photographs, or undesirable photographs from behind the subject. Capturing desirable photographs of loved ones in action on the mountain is therefore often an inconvenient, difficult, or expensive task.

Based on the foregoing, it is desirable to provide a camera system to automatically capture quality photographs of customers participating in vacation activities.

It is further desirable to provide a tracking system capable of identifying the location of customers.

It is further desirable to provide a control system capable of matching the subject of each photograph with the respective customer and displaying photographs to the customer.

It is further desirable to provide an interface accessible from a customer's smart device, laptop computer, or other capable device for accessing, purchasing, downloading, and/or storing photographs taken.

It is further desirable to provide an external storage system in communication with the camera system for storing photographs.

### SUMMARY OF THE INVENTION

In general, in a first aspect, the invention relates to a camera system for automatically taking, storing, and displaying photographs comprising a camera, a digital storage device in communication with the camera, a tracking system, and a display interface in communication with the digital storage device and the tracking system. The invention further relates to a method for using the camera system.

The camera of the invention may further comprise one or more of the following: motion detection software capable of signaling the camera to take a photograph as a customer comes into view, an enclosure capable of protecting the camera from environmental hazards, and/or a gimbal attached to the camera.

The tracking system of the invention may further comprise one or more of the following: a QR code and corresponding decoding software, a radio frequency identification tag and reader, global positioning system software, a blinking light and corresponding decoding software, and/or a reflective marker and corresponding software.

The control system of the invention may use the data from the tracking system to calculate the position of the participants relative to the camera system and manipulate the photograph taken and/or camera position for maximum effectiveness.

The display interface of the invention may comprise a website or smartphone application. The interface may display to the customer photographs of him or herself. The device may also display tracking information to the customer.

The invention also includes a method for taking a photograph, identifying the subject of the photograph, storing the photograph, and displaying the photograph.

The step of taking a photograph may comprise automatically taking a photograph with a camera as a subject passes into view of the camera.

The step of identifying the subject of a photograph may comprise one or more of the following: reading a QR code visible on the clothing of the subject, detecting a radio frequency identification tag with a radio frequency identification reader when the subject is in view or in range of a camera, tracking the subject's location with global positioning system data, reading the color of a reflective marker on the clothing of the subject, and/or reading the pattern of a blinking light visible on the clothing of the subject.

### BRIEF DESCRIPTION OF THE DRAWINGS

FIG. 1 is a diagram showing one embodiment of the interactions of the camera system, control system, tracking system, and user interface.

FIG. 2 is a diagram showing an embodiment of the system with interactions of the camera system, control system, tracking system, user interface, and data storage.

FIG. 3 is a diagram showing interactions of the control system with the location tracking subsystem on a user's phone.

FIG. 4 is a drawing showing an embodiment of the invention as used on a ski slope.

FIG. 5 is a side view of an embodiment of the camera mount and enclosure.

FIG. 6 is a front view of an embodiment of the camera mount and enclosure with a camera therein.

FIG. 7 is a perspective view of an embodiment of the camera mount and enclosure.

FIG. 8 is a drawing depicting several embodiments of the tracking system.

FIG. 9 is a drawing depicting a user interface on a mobile phone.

FIG. 10 is a drawing depicting a motion tracking system.

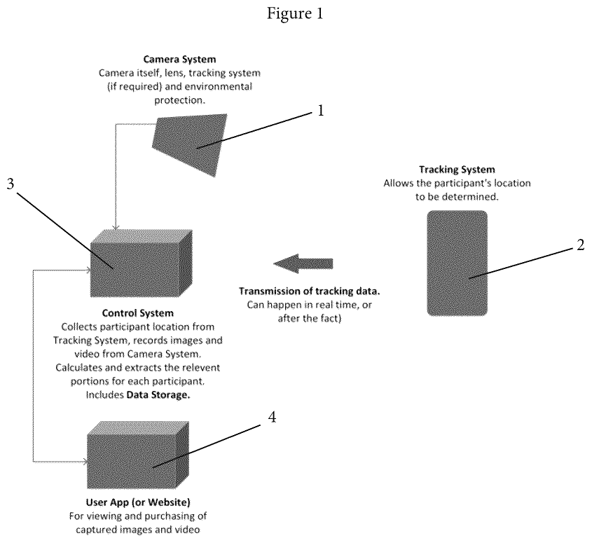

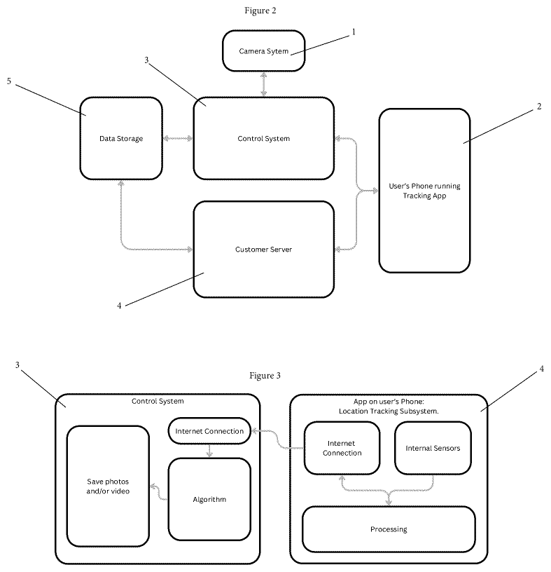

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a system for automatically taking, storing, and displaying photographs of customers participating in certain activities. The invention may comprise one or more camera systems 1, a tracking system 2, a control system 3, and a client-side interface 4. The invention may detect when a customer is in range and/or in frame of the camera system 1, take a photograph of the customer, transfer the photograph to an external storage media 5, and make the photograph available to the customer on a client-side interface 4 for viewing and/or purchase. The invention may take a single photograph, a series of photographs, or a video of the customer, after which the customer can select the most desirable photographs. By way of example but not limitation, this invention may be used at a ski resort to capture action shots of skiers at various points on a slope.

The camera system 1 may comprise a camera 6. The camera 6 used with this invention may be of various quality and type, depending on the application. One or more of the cameras 6 may have sufficient dynamic range for a ski resort application, to ensure dark-colored outfits on skiers may be displayed with sufficient clarity against a white background. One or more of the cameras 6 may be a digital single-lens reflex camera or a mirrorless camera. One or more of the cameras 6 may be sufficiently high resolution for fixed-placement applications. One or more cameras 6 may comprise a sufficiently wide lens to enable capture of multiple subjects over a large area within a photograph. This wide lens along with a high resolution image further may allow for isolation of individual subjects from the photograph, eliminating the need for moving the camera. One or more of the cameras 6 may also be reasonably durable in extreme temperatures. One or more of the cameras may be able to be controlled via a control system 3.

One or more of the cameras 6 may be housed in one or more enclosures 7 to protect the one or more cameras 6 environmental degradation. The enclosure 7 may be water resistant and/or temperature controlled. The enclosure may comprise a viewing window 8 through which the camera 6 can take photographs from inside the enclosure 7. The enclosure 7 may comprise a system for clearing the viewing window of obstructions, such as a wiper system or heating system for snow applications.

One or more of the cameras 6 may be in communication with a control system 3 and/or other software or hardware such as a motion detector 9 that detects motion in the view of the camera 6 and triggers the camera 6 to take a photograph.

One or more of the cameras 6 may be placed on a fixed stand or platform or may be attached to a movable gimbal 10. This may be a separate gimbal 10 attached to the camera 6, or a camera and gimbal combination device. The gimbal 10 may be capable of positioning the camera 6 along the three axes of movement. The gimbal 10 may be controllable by software. The software may direct the gimbal 10 to follow a subject's movement. The software may also direct the gimbal 10 to avoid shots into the sun or account for other environmental factors such as cloud cover. Any camera 6 on a gimbal 10 may not need as high of a resolution as a fixed camera 6.

In one embodiment of this invention applied to a ski resort, one or more of the cameras 6 or camera and gimbal combinations may be affixed to a movable mechanism on a zip-line or rail. The camera 6 may follow and take photographs of a skier as a skier moves down a mountain slope. In a similar application, a backward-facing camera 6 may be placed on or incorporated in the apparel of another skier. The control system 3 may detect when a customer is in view of the camera 6 and take photographs. One or more of the cameras 6 may also be positioned on a drone, where the drone follows a subject as it takes photographs.

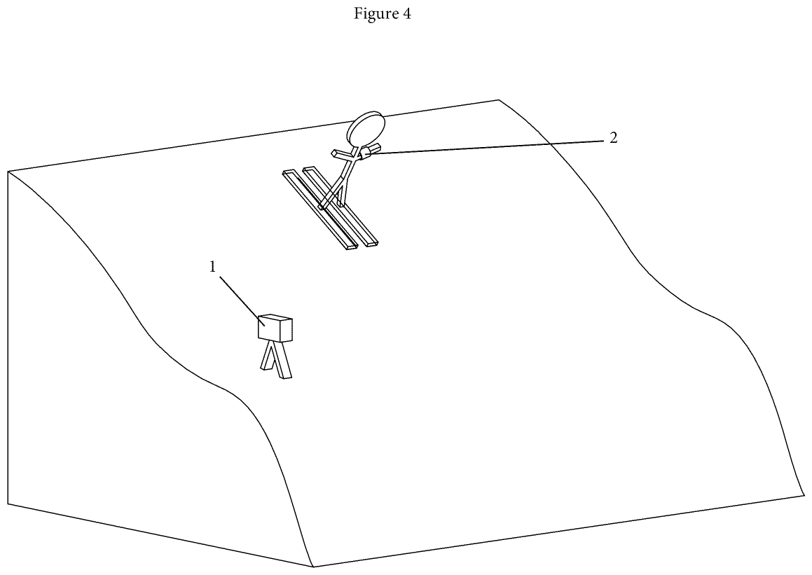

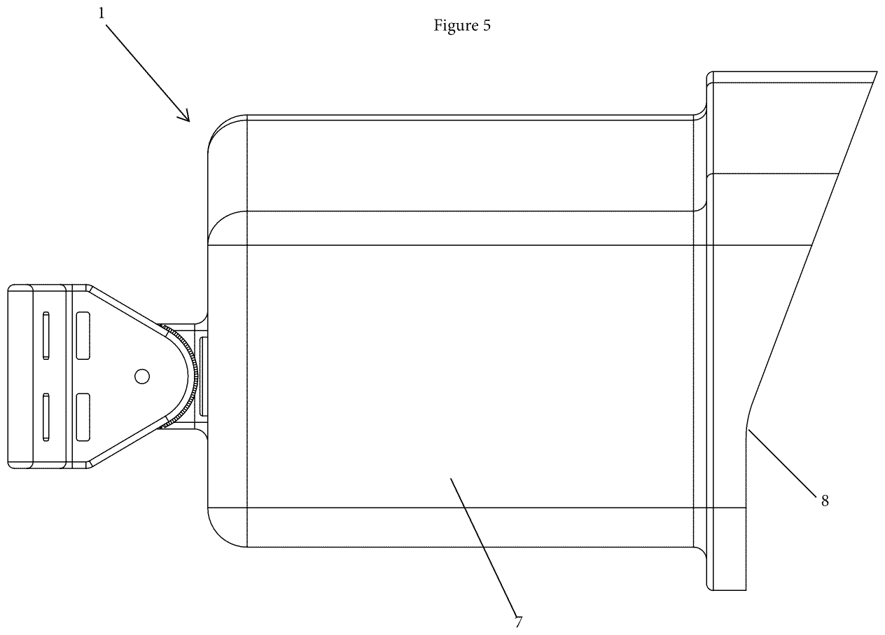

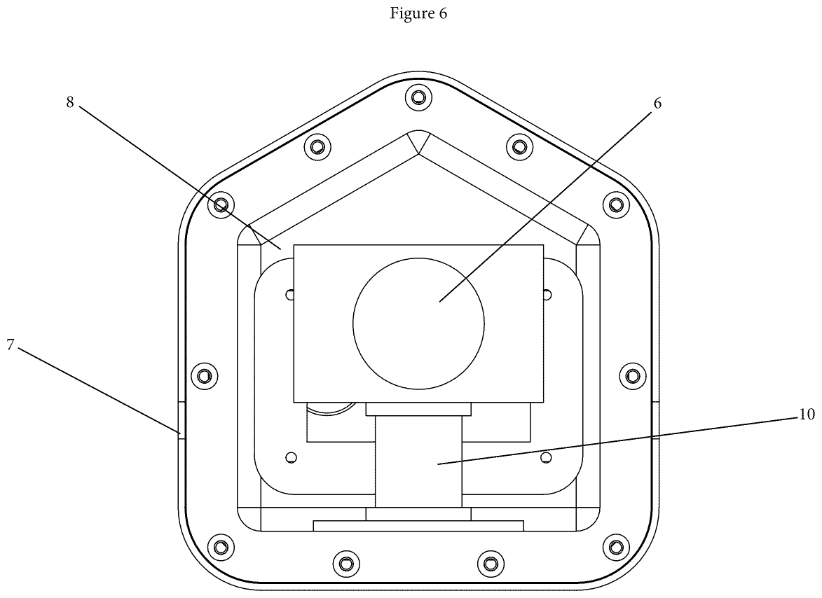

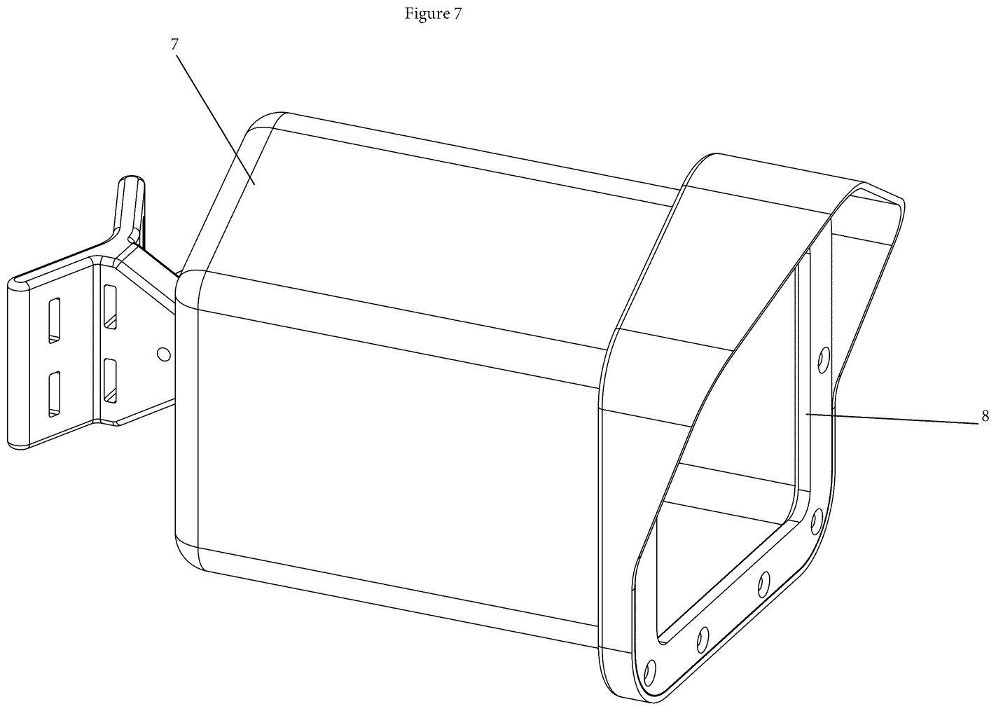

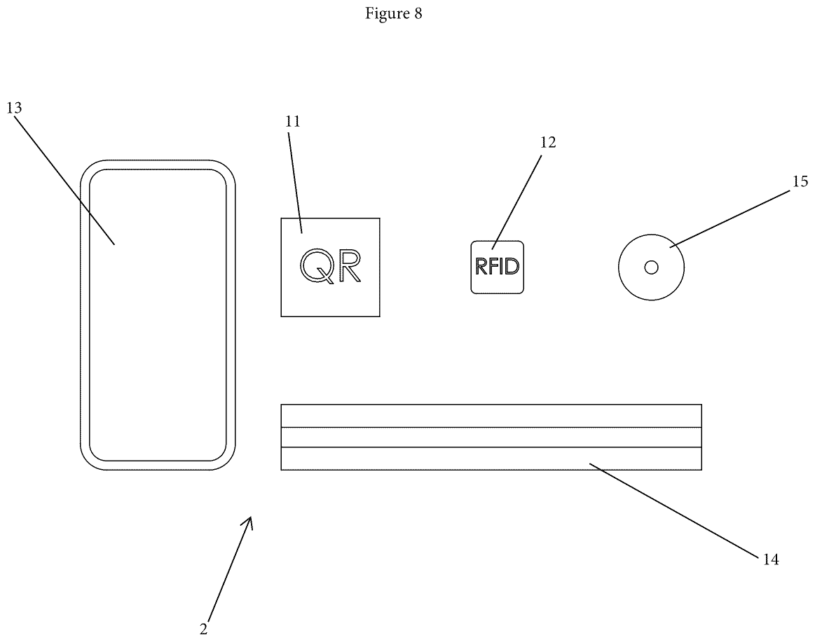

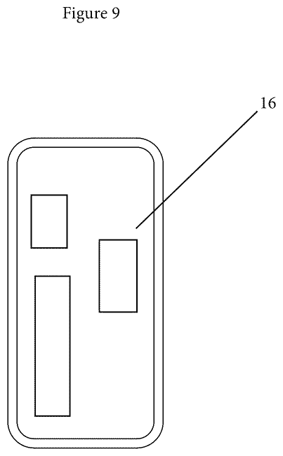

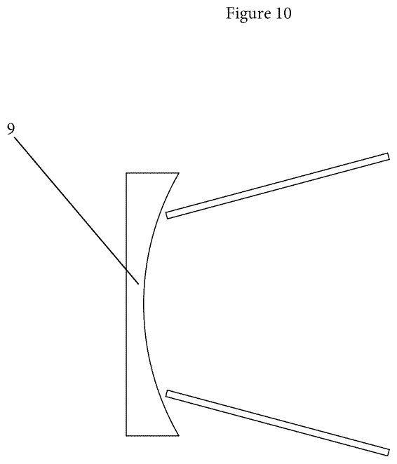

One or more of the cameras 6 or camera and gimbal combinations may be placed at various locations throughout an area. By example but not limitation, a ski resort may have cameras placed at various locations along various slopes, as depicted in FIG. 4. In order to capture quality shots of individual customers, one or more cameras may be positioned strategically at bottleneck locations to increase the likelihood of capturing a participant within the field of view of the camera. One or more of the cameras may also be positioned at other desirable locations, such as next to a ramp or trick location on a slope.

One or more of the cameras may be in communication with a control system 3, which itself includes or communicates with a data storage unit 5. The data storage unit 5 may be capable of storing large amounts of data. The system may further be in communication with a client-side interface 4.

The camera system 1 may be in communication with the control system 3 which may be capable of communicating with the camera system 1 and a tracking system 2 to pair photographs with corresponding customers.

The tracking system 2 may be capable of tracking the location of customers. In one embodiment of this invention, a customer may display a quick response (QR) code 11 on the outer portion of their body or clothing visible to the camera. This embodiment may require one or more cameras of sufficiently high speed to accurately capture the QR code 11. The QR code 11 may be matched with identifying data by the control system 3 so that a photograph of a customer displaying a QR code 11 can be paired with the correct customer.

Another embodiment of this invention may utilize radio frequency identification (RFID). In this embodiment, an RFID tag 12 may contain identifying data and be contained on or in a customer's clothing. Antennas may be positioned capable of reading said RFID tag 12 and transmitting the data to the control system 3, where photographs taken could then be matched according to the RFID tag 12 read by the antenna at the time.

Another embodiment of this invention may utilize an application on a customer's personal mobile device 13. This embodiment would track the customer's position via GNSS/GPS, and transmit this information via cellular or Wi-Fi connection. If a customer does not have a mobile device 13 capable of utilizing this application, similar devices may be loaned or rented to customers. The mobile device 13 may send tracking data to the control system 3 in real time, or the data may be stored and sent at a later time. This may be useful particularly in cases where cellular or Wi-Fi connection may be spotty or unavailable.

Another embodiment of this invention may include a custom tracking device provided to customers. This may be a modified existing device, or a new hardware device. This device may utilize a cellular, Wi-Fi, or LoRa connection.

Another embodiment of this invention may include facial or clothing recognition software capable of recognizing customers in photographs based upon their current appearance.

Another embodiment of this invention may include a reflective marker 14 on the clothing of a customer. This marker 14 may reflect a color specific to the customer currently bearing it, and a camera system 1 may capture this marker 14 with sufficient clarity so that the control system 3 may compute the color of the marker 14 captured and match the photograph with the customer bearing the marker 14.

Another embodiment of this invention may be a blinking marker 15 worn by a user capable of blinking a code to the camera system 1. The code may be specific to the wearer and be used to identify the wearer through a decoding process executed by the camera system 1. The light emitted by the blinking marker 15 may be visible to the naked eye or may be infrared. This system may require a camera 6 of sufficient speed to capture the code emitted by the marker. A computer may utilize multiple still photographs or video captured by the camera 6 to compute the code emitted and match the code with the wearer of the marker.

Yet another embodiment of this invention may comprise a sensor device worn by a customer which detects markers in the terrain and transmits that location data back to a central computer where location of the customer is computed.

The invention may also comprise a control system 3. The control system 3 may receive tracking data from the tracking system 2 and images and/or video from the camera system 1. The control system 3 may calculate the location of the subject at the time the photograph was taken and isolate the appropriate portion of the photograph or video for display to the customer. The control system 3 may comprise an algorithm which compares a user location to a known location, angle, field of view, and other data of the camera and terrain to determine if the user is in frame and calculate adjustments to camera position needed. The control system 3 may use tracking data to direct a camera 6 via gimbal 10 to move in relation to a passing subject and capture images or video. The control system 3 may be capable of interpolating the expected position of a subject in the event of incomplete or insufficient data. The control system 3 may also comprise artificial intelligence software capable of refining captured imagery, suggesting the most desirable photos or videos to the customer, and in some embodiments may record a participant's statistics and performance metrics for sporting applications. Performance metrics may be made available to third-parties, such as sports fans or recruiters.

The invention may comprise a client-side interface 4 capable of displaying photographs of the user for selection, viewing, and/or purchase. The interface 4 may communicate with a customer service and may be embodied in a website or application available on mobile devices. The interface 4 may be capable of handling payment from customers or may direct customers to a third-party application for payment.

The client-side interface 4 may also comprise a user interface 16 capable of displaying tracking data obtained by the tracking device 2. This data may be displayed in the form of a map showing where the user was for a certain period of time. The user interface 16 may allow certain individuals to track others as well, such as parents tracking the location of their children. The user interface 16 may allow individuals to communicate with one another. The user interface 16 may also display a map of cell coverage quality within a specified area. The user interface 16 may allow customers to edit images such as, for example, cropping the images or adding filters.

Whereas, the devices and methods have been described in relation to the drawings and claims, it should be understood that other and further modifications, apart from those shown or suggested herein, may be made within the spirit and scope of this invention.

What is claimed is:

1. A system for capturing and displaying images comprising:
a camera;
a tracking system;
a control system in communication with the camera and the tracking system; and
a display interface in communication with the digital storage device and the tracking system.

2. The system of claim 1 further comprising a motion detection system capable of signaling the camera to take a photograph when a person passes in view of the camera.

3. The system of claim 1 where the tracking system further comprises:
a QR code; and
software capable of reading and decoding the QR code from images taken by the camera.

4. The system of claim 1 where the tracking system further comprises:
a radio frequency identification tag; and
a radio frequency identification reader.

5. The system of claim 1 where the tracking system further comprises:
a GPS-enabled smartphone device; and
a software application in cellular communication with the smartphone device.

6. The system of claim 1 where the tracking system further comprises:
a colored reflective marker; and
software capable of detecting the colored reflective marker from images taken by the camera.

7. The system of claim 1 where the tracking system further comprises:
a blinking light; and
software capable of detecting a pattern of the blinking light from images taken by the camera.

8. The system of claim 1 further comprising:
an enclosure capable of shielding the camera from environmental hazards; and
a translucent section of the enclosure.

9. The system of claim 1 where the camera is mounted on a gimbal.

10. The system of claim 1 where the control system is capable of identifying a subject of a photograph taken by the camera.

11. The system of claim 1 where the display interface is a website.

12. The system of claim 1 where the display interface is a software application running on a mobile device.

13. The system of claim 11 where the display interface is capable of displaying photographs to a user.

14. The system of claim 12 where the display interface is capable of displaying photographs to a user.

15. The display interface of claim 11 where the display interface is capable of displaying a user's tracking data within a specified time frame.

16. The display interface of claim 12 where the display interface is capable of displaying a user's tracking data within a specified time frame.

17. A method for automatically taking, storing, and displaying photographs of a customer to the customer comprising:
taking a photograph with a camera;
identifying a subject of the photograph;
storing the photograph in a digital medium; and
displaying the photograph to the customer.

18. The method of claim 17 where the photograph is taken automatically as the customer passes into view of the camera.

19. The method of claim 17 where the customer is identified in the photograph by reading a QR code visible on clothing worn by the customer.

20. The method of claim 17 where the subject is identified by detecting a radio frequency identification tag with a radio frequency identification reader when the customer is in view or in range of the camera.

21. The method of claim 17 where the customer is identified by tracking their location with global positioning system data.

22. The method of claim 17 where the customer is identified by reading a colored reflective marker visible on clothing worn by the customer.

23. The method of claim 17 where the customer is identified by reading a pattern of blinking light visible on clothing worn by the customer.
